(19) United States
(12) Patent Application Publication
(10) Pub. No.: US 2011/0090227 A1
(43) Pub. Date: Apr. 21, 2011

(54) Point Selector For Graphical Displays

(75) Inventor: Cyrille De Brebisson, Boise, ID (US)

(73) Assignee: Hewlett-Packard Development Company

(21) Appl. No.: 12/996,734

(22) PCT Filed: Jun. 10, 2008
(86) PCT No.: PCT/US2008/066385

§ 371 Date: Dec. 7, 2010

(51) Int. Cl. G06F 3/033; G06T 11/20

(52) U.S. Cl. 345/440; 345/157

(57) ABSTRACT

Systems, methods, and other embodiments associated with selection pointers are described. One example computer-implemented method includes generating and displaying a pointer on a display screen. The pointer is formed with a selection area defined by multiple pixels that are adjacent to each other and intersect at a common point. In response to a selection event, a location of the common point of the pointer on the display screen is determined and a value is returned from a graphical object on which the pointer is displayed. The value is determined from the location of the common point of the pointer.

### BACKGROUND

In computing devices and graphical user interfaces, a graphical pointer is used as an indicator to show the position on a computer monitor or other display device that will respond to input. Pointers are also called mouse cursors since the pointer is typically controlled by actions from a mouse input device. In response to a selection, the computer would determine the location of the pointer and decide how to respond. However, the location of the pointer can typically cover an area that may correspond to multiple values or objects on the display that the pointer is displayed upon. In mathematical applications where a user is trying to select a precise value from, for example, a mathematical graph, the pointer does not correspond to a single value but an interval or a range of possible values.

This is also the case for a cross-hair pointer that has a single pixel as its center point. The signal pixel may cover an interval of values on a graph because a single pixel in the graph may represent an interval of values. For example, on a mathematical graph displayed on a computer or calculator screen, a precise selection of a point for information gathering is difficult to do because every pixel column may represent, not a single value, but an interval. Suppose a graph is formed by 100 pixel columns, where the minimum and maximum values are 0 and 10, respectively. Then, each column represents a span of 0.1. Thus selecting the first column pixel does not select point 0, but the interval from 0 to 0.1.

In the past, each pixel column would be assumed to have the value of the point on the right, left or center of the pixel column, and the selection would be done by a cross hair, typically a single width 5*5 pixel graphic that looks like a plus “+” sign. This graphic would specify a single pixel at the center of the + sign as the selection area. However, a single pixel has a two dimensional area from its left side to its right that may cover an interval of values in an underlying graph. Thus a pixel and does not provide a specific selection point but an area.

### BRIEF DESCRIPTION OF THE DRAWINGS

The accompanying drawings, which are incorporated in and constitute a part of the specification, illustrate various example systems, methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1a illustrates one embodiment of a graphical pointer.

FIG. 1b illustrates an enlarged view of the center pixels from the pointer of FIG. 1a.

FIG. 2 illustrates one embodiment of a display with an example mathematical graph.

FIG. 3 illustrates another example method associated with graphical selection pointer.

FIG. 4 illustrates another embodiment of method associated with generating and controlling a pointer.

FIG. 5 illustrates an example computing environment in which example systems and methods, and equivalents, may operate.

### DETAILED DESCRIPTION

Example systems, methods, computer-readable medium and other embodiments are provided relating to computing systems and selection pointers. In one embodiment, a graphical pointer is provided that defines a mathematical selection point. As such the selection point is a dimensionless point rather than a single pixel that has dimension. One example graphical pointer is provided that is generated with a selection area defined by multiple pixels. The multiple pixels are positioned adjacent to each other and intersect at a common point. The common point is then used as a dimensionless selection point.

Defining a single point as the selection point provides for more precise selection. In one example when used with graphs that represent mathematical functions, precise selection of a value from the graph can be made based on the location of the selection point of the pointer as it corresponds to a location on the graph.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

“Computer component”, as used herein, refers to a computer-related entity (e.g., hardware, firmware, software in execution, combinations thereof). Computer components may include, for example, a process running on a processor, a processor, an object, an executable, a thread of execution, and a computer. A computer component(s) may reside within a process and/or thread. A computer component may be localized on one computer and/or may be distributed between multiple computers.

“Computer-readable medium”, as used herein, refers to a medium that stores signals, instructions and/or data. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an ASIC, a CD, other optical medium, a RAM, a ROM, a memory chip or card, a memory stick, and other media from which a computer, a processor or other electronic device can read.

“Logic”, as used herein, includes but is not limited to hardware, firmware, software in execution on a machine, and/or combinations of each to perform a function(s) or an action(s), and/or to cause a function or action from another logic, method, and/or system. Logic may include a software controlled microprocessor, a discrete logic (e.g., ASIC), an analog circuit, a digital circuit, a programmed logic device, a memory device containing instructions, and so on. Logic may include one or more gates, combinations of gates, or other circuit components. Where multiple logical logics are described, it may be possible to incorporate the multiple logical logics into one physical logic. Similarly, where a single logical logic is described, it may be possible to distribute that single logical logic between multiple physical logics.

An “operable connection”, or a connection by which entities are “operably connected”, is one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, software). Logical and/or physical communication channels can be used to create an operable connection,

“Signal”, as used herein, includes but is not limited to, electrical signals, optical signals, analog signals, digital signals, data, computer instructions, processor instructions, messages, a bit, a bit stream, or other means that can be received, transmitted and/or detected.

“Software”, as used herein, includes but is not limited to, one or more executable instruction that cause a computer, processor, or other electronic device to perform functions, actions and/or behave in a desired manner. “Software” does not refer to stored instructions being claimed as stored instructions per se (e.g., a program listing). The instructions may be embodied in various forms including routines, algorithms, modules, methods, threads, and/or programs including separate applications or code from dynamically linked libraries.

“User”, as used herein, includes but is not limited to one or more persons, software, computers or other devices, or combinations of these.

Some portions of the detailed descriptions that follow are presented in terms of algorithms and symbolic representations of operations on data bits within a memory. These algorithmic descriptions and representations are used by those skilled in the art to convey the substance of their work to others. An algorithm, here and generally, is conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic, and so on. The physical manipulations create a concrete, tangible, useful, real-world result.

It has proven convenient at times, principally for reasons of common usage, to refer to these signals as bits, values, elements, symbols, characters, terms, numbers, and so on. It should be borne in mind, however, that these and similar terms are to be associated with the appropriate physical quantities and are merely convenient labels applied to these quantities. Unless specifically stated otherwise, it is appreciated that throughout the description, terms including processing, computing, determining, and so on, refer to actions and processes of a computer system, logic, processor, or similar electronic device that manipulates and transforms data represented as physical (electronic) quantities.

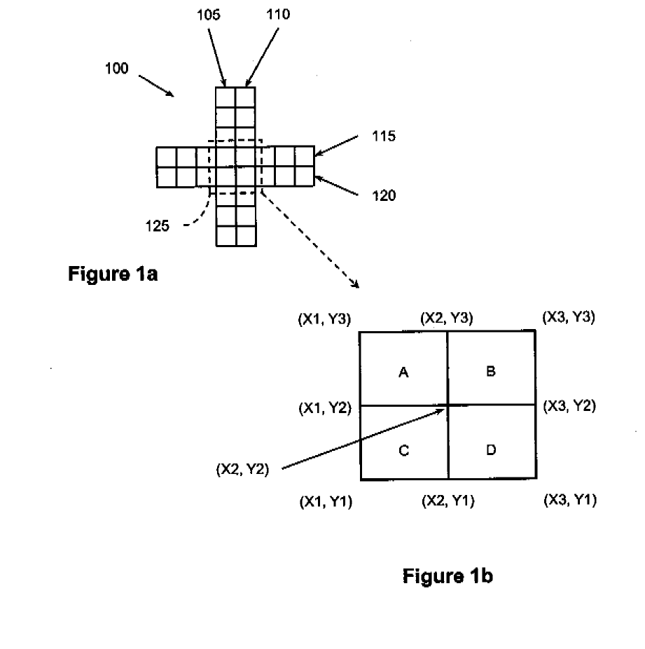

With reference to the figures, FIG. 1a illustrates one embodiment of a graphical pointer 100. The pointer 100 is formed as a double pixel wide cross-hair with two vertical columns of pixels 105, 110 and two horizontal rows of pixels 115, 120. Each pixel is represented by a single square and each column and each row is shown with eight (8) pixels. Of course, other amounts of pixels can be used to form the pointer 100 and other shapes can be defined.

The graphical pointer 100 is defined with a selection area 125 formed by multiple pixels positioned adjacent to each other and that intersect at a common point. An enlarged view of the selection area 125 is illustrated in FIG. 1b. The selection area is shown having four pixels A, B, C, and D. The corner points of the pixels are labeled with (X₁₋₃, Y₁₋₃) coordinates to illustrate that a pixel is a two dimensional object even though a pixel is generally thought of as the smallest single component of an image. The coordinates do not necessarily correspond to actual (X, Y) coordinates of a display screen.

To provide a more precise selection pointer, the selection area 125 defines an intersection point of the pixels A, B, C, and D as the selection point. The intersection point is shown at point (X2, Y2), which is a common corner point of the illustrated square shaped pixels. Thus, the pointer 100 changes the representation of a mathematical point from a single pixel, which has a dimension due to the discrete representations of points on a display screen, to a dimensionless point. This point is smaller in size than the pixel. As such when a selection is made, the location of the intersection point is used to identify a more exact position on an object that underlies the pointer 100.

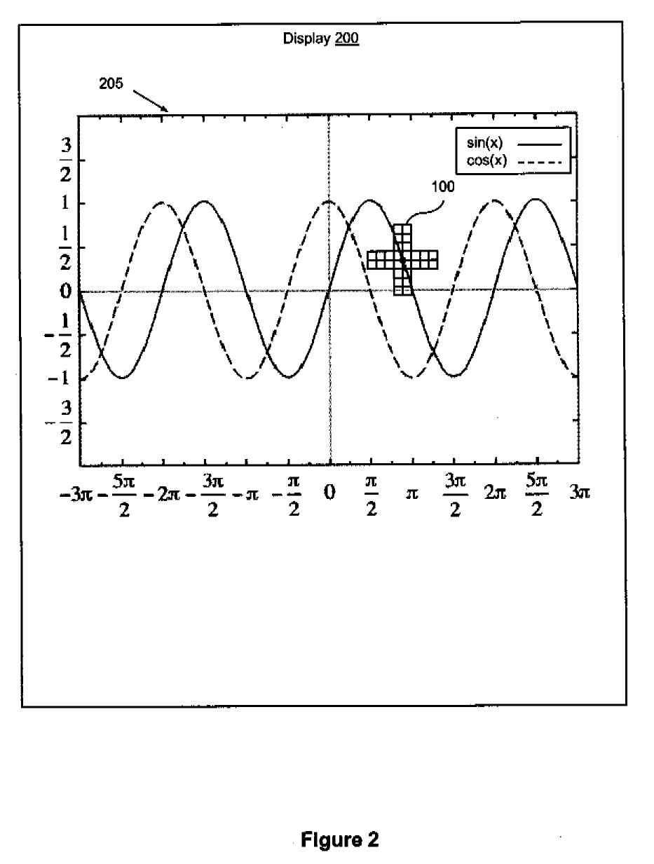

Illustrated in FIG. 2 is an example display screen 200 showing an example graph 205 of a mathematical function, which in the example is two graphs, one for the sine function y=sin(x) shown as the solid line and one for the cosine function y=cos(x) shown as the dashed line. The graph 205 is also illustrated with the pointer 100 shown in an enlarged form for easier visibility. Of course, the pointer 100 can be generated in a smaller or larger size. In the example, the intersection point of the four center pixels (e.g. the selection point) of the pointer 100 is shown with a black dot to highlight its position. As previously explained, a single pixel of the pointer may overlap an interval of values from the underlying graph (e.g. a single pixel in the graph can represent an interval of values). Instead, defining and using the intersection point provides a more precise correspondence between pointer selection and a graph value.

It will be appreciated that a precise selection may not be as necessary on continuous functions like sin(x). However for functions like 1/X or sin(1/X), precise selection becomes more relevant such as when trying to select and return a value on the graph near point X=0 because the function is discontinuous at point 0.

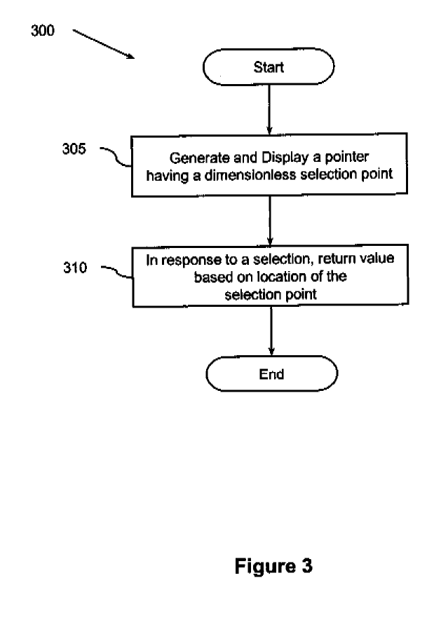

Illustrated in FIG. 3 is one embodiment of a method 300 that is associated with generating and controlling a graphical pointer. Example methods may be better appreciated with reference to flow diagrams. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be used to implement an example methodology. Blocks may be combined or separated into multiple components. Furthermore, additional and/or alternative methodologies can employ additional, not illustrated blocks.

With reference to FIG. 3, method 300 may initiate with generating and displaying a graphical pointer having a dimensionless selection point (block 305). The pointer can be generated by defining the pointer as a graphical object with a desired shape formed by pixels. The pointer includes a selection area defined by multiple pixels that are positioned adjacent to each other and intersect at a common point. If the pointer is formed with a cross-hair shape, the selection area is typically in the center. Other shapes may have the selection area near an edge.

Once the pointer is displayed on a display screen, the method can respond to a selection event. In a system were the pointer is controlled by a mouse or other input device, the selection event corresponds to clicking a mouse button or otherwise initiating a selection (e.g. pressing the enter key). Of course, the selection event can be programmed in various ways depending on the application. In response to the selection event, the method determines a location of the common point of the pointer on the display screen and returns a value from a graphical object on which the pointer is displayed (block 310). The value is determined from the location of the common point of the pointer. Thus, the location of the common point, which is a dimensionless point, corresponds to a more specific point on the graphical object that is being selected than a pixel. In the case where the graphical object is a mathematical graph, a value from the graph is returned that corresponds to the location of the common point.

In another example, the returning action can include determining a numerical value associated to an (x, y) coordinate within the graphical object, where the location of the common point of the pointer designates the (x, y) coordinate. The numerical value can then be transmitted to a processor as a signal that represents the numerical value.

In another embodiment where the graphical object is a graph, the method can include displaying a graph of a mathematical function, which is the graphical object on which the pointer is displayed. Then in response to the selection event, the value is returned at a mathematical point on the graph that corresponds to the location of the common point of the pointer on the graph. In one implementation, the location can be determined by an (x, y) coordinate and the value is determined by solving the mathematical function for y using the x value as input and/or solving for x using the y value as input. Of course, multi-variable functions can also be used as the graph.

Regarding the form of the pointer, in one embodiment the pointer is generated as a cross hair form and the selection area is at an intersection of the cross hair. In another embodiment, the selection area is defined by 2-by-2 pixels where the common point is a point of interception of the 2-by-2 pixels. This configuration is illustrated as selection area 125 shown in FIG. 1a. As another example, the pointer is generated to have the common point as a dimensionless selection point. Three adjacent pixels can also be arranged to intersect at a common point.

In one example, a method may be implemented as computer executable instructions. Thus, in one example, a computer-readable medium may store computer executable instructions that if executed by a machine (e.g., processor) cause the machine to perform the method. While executable instructions associated with the above method are described as being stored on a computer-readable medium, it is to be appreciated that executable instructions associated with other example methods described herein may also be stored on a computer-readable medium.

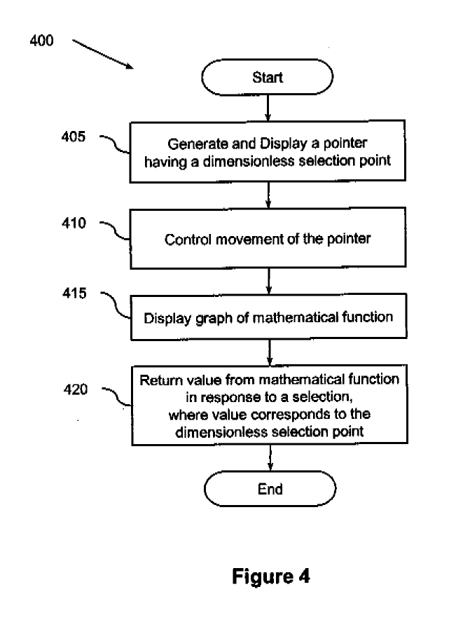

With reference to FIG. 4, another embodiment of an example computer-implemented method is illustrated for a selection pointer for a mathematical graph. The method 400 includes displaying, on a display, a graphical pointer having a selection area defined by multiple pixels that are adjacent to each other and intersect at a dimensionless point (block 405). One example is the double wide cross hair pointer shown in FIG. 1a that forms a dimensionless point at its center. Movement of the graphical pointer is controlled on the display (block 410). The movement would be in response to a user inputting actions using an input device like a mouse, keyboard, touch pad, or other pointer controlling device.

A graph is displayed that represents a mathematical function where each (x, y) coordinate of the graph represents a value of the mathematical function (block 415). It will be appreciated that the (x, y) coordinates from the graph may not correspond to the (x, y) coordinates of the display screen. In response of a selection event, a signal is generated that represents a value from the mathematical function (block 420). The value is determined from a single (x, y) coordinate from the mathematical function that is identified by a location of the dimensionless point of the graphical pointer on the graph at the time of the selection event. In this manner, a more precise selection can be made and more precise values can be returned when collecting information from a mathematical graph using the graphical pointer.

In another example, the method 400 can also include, prior to displaying the graphical pointer, generating the graphical pointer to include four adjacent pixels arranged to intersect at a common point that is the dimensionless point. In one embodiment, the graphical pointer is generated as a crosshair pointer formed of a double wide vertical column of pixels and a double wide horizontal row of pixels that intersect at the selection area.

It will be appreciated that while the figures illustrate various actions occurring in serial, one or more of the actions could occur substantially in parallel.

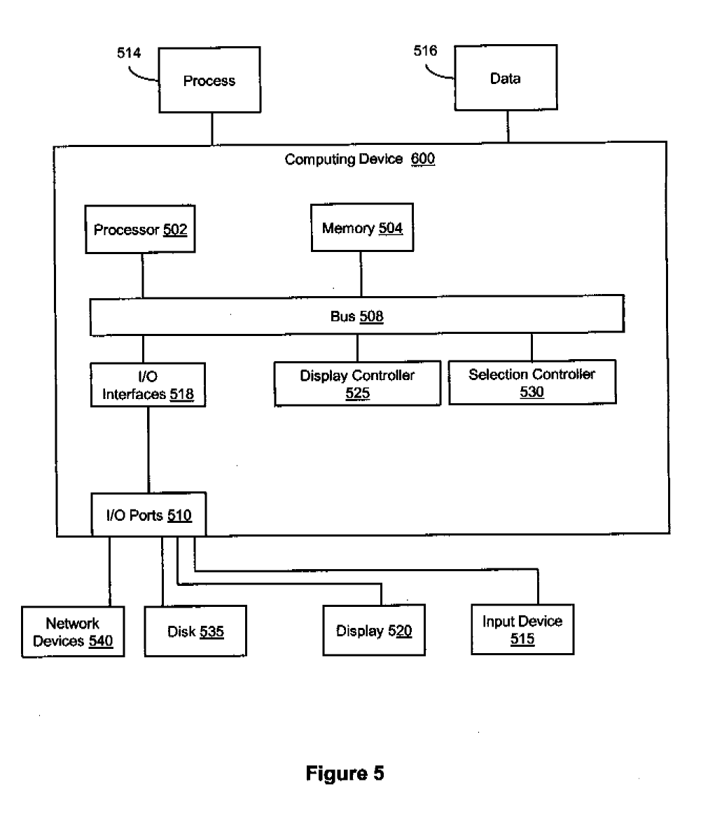

FIG. 5 illustrates an example computing device 500 in which example systems and methods described herein, and equivalents, may operate. The example computing device may be a desktop/laptop computer, a portable computer, a hand-held device, a calculator, or other electronic device that can use graphical user interfaces and graphical selection pointers.

The computing device 500 includes a processor 502, a memory 504, and input/output (I/O) ports 510 operably connected by a bus 508. An input device 515 like a mouse can be connected to an I/O port 510. The input device 515 can also include a built-in touch pad for controlling a mouse pointer and/or a keyboard, which is configured to control the movement of a graphical pointer on a display 520. The display 520 can be a separately attached device or a built-in display for displaying a graphical user interface, images, and other information.

In one example, the computer 500 may include a display controller 525 implemented as logic and configured to display a graph on the display 520 that represents a mathematical function where each (x, y) coordinate of the graph represents a value of the mathematical function. The computing device 500 can also include a selection controller 530 configured to generate and display a graphical pointer on the display 520. The selection controller 530 can be, for example, part of an input device driver like a mouse driver. The graphical pointer is formed having a selection area defined by multiple pixels that are adjacent to each other and share a common corner point. As previously explained, one example includes the pointer 100 shown in FIG. 1a.

The selection controller 530 is further configured to move the graphical pointer on the display 520 in response to events from the input device 515. In response of a selection event from the input device 515, the selection controller 530 is configured to return a value from the mathematical function where the value returned corresponds to a location of the common corner point on the graph at the time of the selection event.

In different embodiments, the controllers 525 and 530 may be implemented in hardware, software, firmware, and/or combinations thereof. While the logic 530 is illustrated as a separate component, it is to be appreciated that in one example, one or both of the controllers 520 and/or 530 could be implemented in the processor 502.

Generally describing an example configuration of the computing device 500, the processor 502 may be a variety of various processors including dual microprocessor and other multi-processor architectures. A memory 504 may include volatile memory and/or non-volatile memory for storing instructions and data. Non-volatile memory may include, for example, ROM, PROM, and so on. Volatile memory may include, for example, RAM, SRAM, DRAM, and so on.

Optionally, a disk 535 may be operably connected to the computing device 500 via, for example, the I/O ports 510 and an input/output interface 518 (e.g., card, device drivers). The disk 535 may be, for example, a magnetic disk drive, a solid state disk drive, a floppy disk drive, a tape drive, a Zip drive, a flash memory card, a memory stick, and so on. Furthermore, the disk 535 may be a CD-ROM drive, a CD-R drive, a CD-RW drive, a DVD ROM, and so on. The memory 504 can store a process 514 and/or a data 516, for example. The disk 535 and/or the memory 504 can store an operating system that controls and allocates resources of the computing device 500.

The bus 508 may be a single internal bus interconnect architecture and/or other bus or mesh architectures. While a single bus is illustrated, it is to be appreciated that the computing device 500 may communicate with various devices, logics, and peripherals using other busses (e.g., PCIE, 1394, USB, Ethernet). The bus 508 can be types including, for example, a memory bus, a memory controller, a peripheral bus, an external bus, a crossbar switch, and/or a local bus.

The input/output devices 515 may be, for example, a keyboard, a microphone, a pointing and selection device, cameras, video cards, displays, and so on. The input/output ports 510 may include, for example, serial ports, parallel ports, USB ports, and wireless connection devices.

The computing device 500 can operate in a network environment and thus may be connected to network devices 540 via the I/O interfaces 518, and/or the I/O ports 510. Through the network devices 540, the computer 500 may interact with a network. Through the network, the computing device 500 may be logically connected to remote computers. Networks with which the computing device 500 may interact include, but are not limited to, a LAN, a WAN, and other networks.

While example systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Therefore, the invention is not limited to the specific details, the representative apparatus, and illustrative examples shown and described. Thus, this application is intended to embrace alterations, modifications, and variations that fall within the scope of the appended claims.

To the extent that the term “includes” or “including” is employed in the detailed description or the claims, it is intended to be inclusive in a manner similar to the term “comprising” as that term is interpreted when employed as a transitional word in a claim.

To the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Gamer, A Dictionary of Modem Legal Usage 624 (2d. Ed. 1995).

To the extent that the phrase “one or more of, A, B, and C” is employed herein, (e.g., a data store configured to store one or more of, A, B, and C) it is intended to convey the set of possibilities A, B, C, AB, AC, BC, and/or ABC (e.g., the data store may store only A, only B, only C, ABB, ABC, B&C, and/or A&B&C). It is not intended to require one of A, one of B, and one of C. When the applicants intend to indicate “at least one of A, at least one of B, and at least one of C”, then the phrasing “at least one of A, at least one of B, and at least one of C” will be employed.

What is claimed is:

1. A computer-implemented method, comprising:
generating and displaying a pointer on a display screen, the pointer having a selection area defined by multiple pixels that are adjacent to each other and intersect at a common point; and
in response to a selection event, determining a location of the common point of the pointer on the display screen and returning a value from a graphical object on which the pointer is displayed, where the value is determined from the location of the common point of the pointer.

2. The computer-implemented method of claim 1 where the returning further includes:
determining a numerical value associated to an (x, y) coordinate within the graphical object, where the location of the common point of the pointer designates the (x, y) coordinate; and
transmitting a signal that represents the numerical value to a processor.

3. The computer-implemented method of claim 1 further including:
displaying a graph of a mathematical function, which is the graphical object on which the pointer is displayed;
where in response to the selection event, returning the value at a mathematical point on the graph that corresponds to the location of the common point of the pointer on the graph.

4. The computer-implemented method of claim 1 where the generating and displaying includes generating the pointer in a cross hair form and where the selection area is at an intersection of the cross hair.

5. The computer-implemented method of claim 1 where the generating including generating the pointer with the selection area defined by 2-by-2 pixels where the common point is a point of interception of the 2-by-2 pixels.

6. The computer-implemented method of claim 1 where the generating includes generating the pointer to have the common point as a dimensionless selection point.

7. A computing system, comprising:
a display;
an input device for controlling movement of a graphical pointer on the display;
a display controller for displaying a graph on the display that represents a mathematical function where each (x, y) coordinate of the graph represents a value of the mathematical function;
a selection controller configured to generate and display the graphical pointer being formed having a selection area defined by multiple pixels that are adjacent to each other and share a common corner point, the selection controller further configured to move the graphical pointer on the display in response to the input device;
the selection controller being further configured to return a value from the mathematical function in response of a selection event from the input device, where the value returned corresponds to a location of the common corner point on the graph at the time of the selection event.

8. The computing system of claim 7, where the graphical pointer is formed of pixels as a crosshair.

9. The computing system of claim 7, where the selection area of the graphical pointer is formed by four pixels that share the common corner point which is a point of intersection of the four pixels.

10. The computing system of claim 7, where the common corner point is smaller in size than a pixel.

11. The computing system of claim 7, where the common corner point is a dimensionless selection point.

12. The computing system of claim 7, where the computing system is a hand-held device.

13. A computer-implemented method comprising:
displaying, on a display, a graphical pointer having a selection area defined by multiple pixels that are adjacent to each other and intersect at a dimensionless point;
controlling movement of the graphical pointer on the display;
displaying a graph that represents a mathematical function where each (x, y) coordinate of the graph represents a value of the mathematical function;
returning a signal that represents a value from the mathematical function in response of a selection event, where the value is determined from a single (x, y) coordinate from the mathematical function that is identified by a location of the dimensionless point of the graphical pointer on the graph at the time of the selection event.

14. The method of claim 13 further including, prior to displaying the graphical pointer, generating the graphical pointer to include four adjacent pixels arranged to intersect at a common point that is the dimensionless point.

15. The method of claim 13 further including generating the graphical pointer as a crosshair pointer formed of a double wide vertical column of pixels and a double wide horizontal row of pixels that intersect at the selection area.
